(19) United States
(12) Patent Application Publication
(10) Pub. No.: US 2025/0053191 A1
(43) Pub. Date: Feb. 13, 2025

(54) SEMICONDUCTOR DEVICE AND SEMICONDUCTOR DIAGNOSTIC DEVICE

(71) Applicant: Renesas Electronics Corporation, Tokyo (JP)

(72) Inventors: Yoichi MAEDA, Tokyo (JP); Jun MATSUSHIMA, Tokyo (JP)

(21) Appl. No.: 18/795,290

(22) Filed: Aug. 6, 2024

(30) Foreign Application Priority Data
Aug. 8, 2023 (JP) 2023-129658

(51) Int. Cl. G06F 1/12

(52) U.S. Cl. CPC G06F 1/12

(57) ABSTRACT

The technology provided enables the acceleration of the clock. The semiconductor device comprises a counter circuit configured to generate a read signal when the count number reaches a predetermined number, a buffer configured to store test data and sequentially output the test data in the order stored when the read signal indicates a valid value, and a first scan test circuit that sequentially captures the test data output from the buffer.

### CROSS-REFERENCE TO RELATED APPLICATIONS

The disclosure of Japanese Patent Application No. 2023-129658 filed on Aug. 8, 2023, including the specification, drawings and abstract is incorporated herein by reference in its entirety.

### BACKGROUND

This disclosure relates to a semiconductor device, for example, it can be applied to a semiconductor device equipped with a scan chain.

There are disclosed techniques listed below.
[Patent Document 1] Japanese Translation of PCT International Application Publication No. 2009-508101

In the field of scan testing, a lock-up latch is used. The lock-up latch is a technology for fixing clock skew between scan shift registers on different branches of the clock tree (Patent Document 1).

### SUMMARY

When the clock is accelerated, even if a lock-up latch is provided between the scan shift registers, normal transfer may not be possible.

Other problems and novel features will become apparent from the description and accompanying drawings of this specification.

A brief explanation of a representative one of this disclosure is as follows. The semiconductor device includes a counter circuit configured to generate a read signal when the count number reaches a predetermined number, a buffer configured to store test data and sequentially output the test data in the order stored when the read signal indicates a valid value, and a first scan test circuit that sequentially captures the test data output from the buffer.

According to the semiconductor device, it is possible to accelerate the clock.

### BRIEF DESCRIPTION OF THE DRAWINGS

FIG. 1 is a diagram explaining the scan test of the semiconductor device.

FIG. 2 is a diagram explaining the scan test of the logic circuit shown in FIG. 1.

FIG. 3 is a block diagram showing the schematic configuration of two logic circuits and their ATPG model in the embodiment.

FIG. 4 is a timing chart when the preceding scan chain and the following scan chain are directly connected.

FIG. 5 is a timing chart when a lock-up latch is provided between the preceding scan chain and the following scan chain.

FIG. 6 is a timing chart when a hold violation occurs when a lock-up latch is provided between the preceding scan chain and the following scan chain.

FIG. 7 is a timing chart when a setup violation occurs when a lock-up latch is provided between the preceding scan chain and the following scan chain.

FIG. 8 is a block diagram showing the configuration of the semiconductor device in the first embodiment.

FIG. 9 is a block diagram showing an example of the configuration of the counter circuit shown in FIG. 8.

FIG. 10 is a block diagram showing an example of the configuration of the FIFO shown in FIG. 8.

FIG. 11 is a block diagram showing an example of the configuration of the transmission circuit shown in FIG. 8.

FIG. 12 is a block diagram showing an example of the configuration of the reception circuit shown in FIG. 8.

FIG. 13 is a timing chart showing the operation of the semiconductor device shown in FIG. 8.

FIG. 14 is a block diagram showing the configuration of the semiconductor device in the second embodiment.

FIG. 15 is a timing chart showing the operation of the semiconductor device shown in FIG. 14.

FIG. 16 is a block diagram showing the configuration of the semiconductor device in the third embodiment.

FIG. 17 is a cross-sectional view showing the schematic configuration of the semiconductor device in the third embodiment.

FIG. 18 is a diagram explaining the scan test of the semiconductor device shown in FIG. 17.

FIG. 19 is a diagram explaining the scan test of the semiconductor device in the comparative example.

FIG. 20 is a block diagram showing the configuration of the semiconductor diagnostic device in the fourth embodiment.

FIG. 21 is a block diagram showing the configuration of the semiconductor device in the fifth embodiment.

FIG. 22 is a diagram showing the circuit data of the semiconductor device shown in FIG. 8.

FIG. 23 is a diagram showing the test design data of the semiconductor device shown in FIG. 8.

FIG. 24 is a diagram showing the ATPG model shown in FIG. 23.

FIG. 25 is a diagram showing the flow of manufacturing, test pattern generation, and diagnosis of the semiconductor device shown in FIG. 8.

### DETAILED DESCRIPTION

Hereinafter, embodiments will be explained using the drawings. However, for the sake of clarification, the following descriptions and drawings are appropriately omitted and simplified. Also, the same reference numerals are attached to the same components, and the description may be omitted.

### Outline of Embodiment

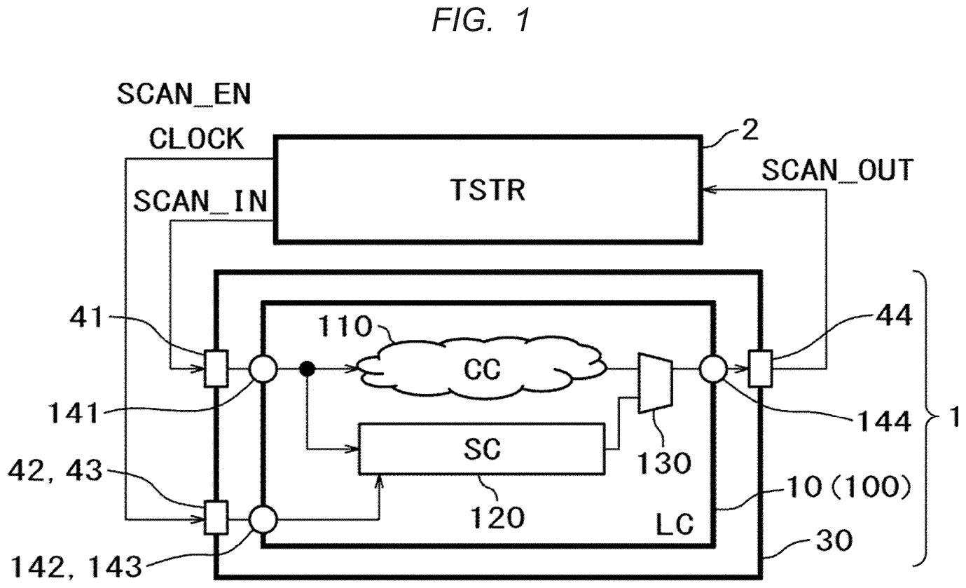

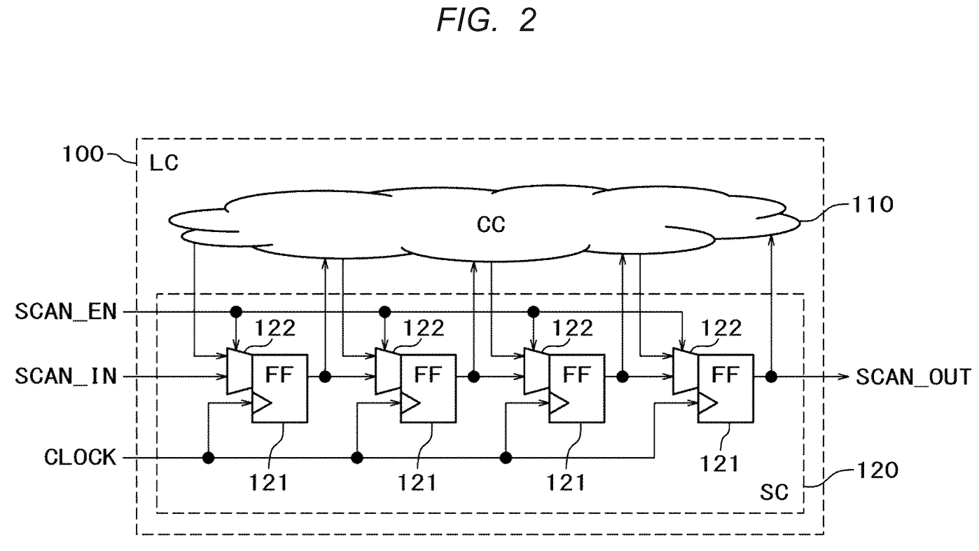

The scan test, which is the premise technology of this disclosure, will be explained using FIGS. 1 and 2.

As shown in FIG. 1, the semiconductor device 1 includes a semiconductor chip 10 and a package substrate 30. The semiconductor chip 10 has a logic circuit (LC) 100. The logic circuit 100 includes a combination circuit (CC) 110, a scan chain (SC) 120, and a multiplexer 130. Also, the semiconductor chip 10 has terminals 141, 142, 143, 144.

The package substrate 30 is provided with external terminals 41, 42, 43, and 44. A scan input signal (SCAN_IN) is input to the external terminal 41, and the external terminal 41 is connected to the terminal 141. A scan enable signal (SCAN_EN) is input to the external terminal 42, and the external terminal 42 is connected to the terminal 142. A clock signal (CLOCK) is input to the external terminal 43, and the external terminal 43 is connected to the terminal 143. A scan output signal (SCAN_OUT) is output from the external terminal 44, and the external terminal 44 is connected to the terminal 144.

The scan test constructs the scan chain 120 by connecting flip-flops (FF) 121 in the logic circuit 100 in a shift register form, and performs input and output of test data by shift operation. The test data includes test patterns and test results.

As a specific operation, the test device (TSTR) 2 enables the SCAN_EN input to the external terminal 41 and inputs the SCAN_IN as a test pattern to the external terminal 41. The SCAN_IN input to the external terminal 41 is sequentially input to each flip-flop 121 via the terminal 141 and the multiplexer (selector) 122, and the test pattern is supplied to the combination circuit 110.

Afterwards, the test device 2 disables the SCAN_EN input to the external terminal 41. Then, the value of the combination circuit 110 is stored in each flip-flop 121 via the multiplexer 122.

Afterwards, the test device 2 enables the SCAN_EN input to the external terminal 41. Then, the value stored in the flip-flop 121 is sequentially output from the external terminal 44 via the multiplexer 130 and the terminal 144 as the SCAN_OUT as a test result. The test device 2 compares the output SCAN_OUT with the expected value. Here, the flip-flop 121 is a flip-flop that captures data signals in synchronization with the rising edge of the clock signal (CLOCK).

The manufacturing test (package test) by the scan test is performed in synchronization with the test device 2. Therefore, in order to operate the scan test correctly, all FF121 in the scan chain 120 need to be synchronously transferred with the CLOCK supplied from the test device 2. Also, SCAN_EN, SCAN_IN, and SCAN_OUT all need to be directly controlled from the test device 2. In addition, the external terminals 41, 42, 43, 44 share the input and output terminals of functions other than the scan test of the logic circuit 100 from the viewpoint of not increasing the external terminals provided on the package substrate 30. SCAN_EN, SCAN_IN, and SCAN_OUT are only valid for input or output during test mode.

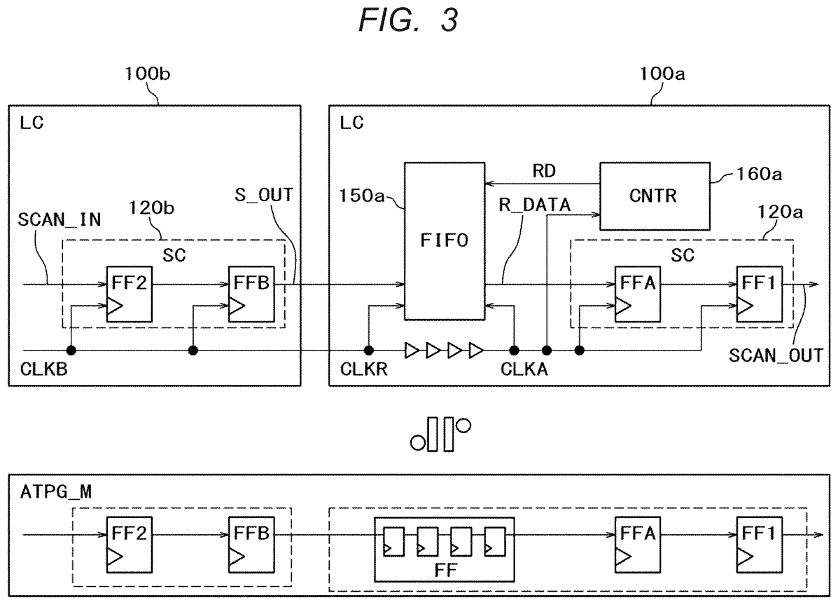

Using FIG. 3, we will explain a technology (embodiment) that can speed up the clock signal of the scan test in a state where the scan chains of multiple logic circuits are connected in series.

The logic circuit 100a as the first semiconductor circuit includes the scan chain 120a as the first scan test circuit, the FIFO (First In First Out) 150a as a buffer, and the counter circuit (CNTR) 160a. The counter circuit 160a controls the read signal (RD) of the FIFO 150a. The FIFO 150a is placed between the scan chain 120a and the scan chain 120b as the second scan test circuit of the logic circuit 100b. The logic circuit 100a includes a combination circuit similar to the combination circuit 110 of the logic circuit 100 shown in FIG. 2.

The scan chain 120a has the same configuration as the scan chain 120 shown in FIG. 2. However, in FIG. 3, the scan chain 120a is described in a simplified manner. For example, the descriptions of SCAN_EN and multiplexer 122 are omitted. Also, only two stages of flip-flops (FFA, FF1) are shown for flip-flop 121. The FFA, FF1 receive CLKA as a first clock signal. CLKA is a delayed clock signal of CLKR as a second clock signal. The scan chain 120a receives read data (R_DATA) from FIFO150a.

The logic circuit 100b as a second semiconductor circuit has the same configuration as the logic circuit 100 shown in FIG. 2. The scan chain 120b has the same configuration as the scan chain 120 shown in FIG. 2. However, in FIG. 3, the scan chain 120b is described in a simplified manner. For example, the descriptions of SCAN_EN and multiplexer 122 are omitted. Also, only two stages of flip-flops (FF2, FFB) are shown for flip-flop 121. The FF2, FFB receive CLKB as a third clock signal. CLKB is input to the logic circuit 100a as CLKR. An output signal (S_OUT) is output from the scan chain 120b.

The asynchronous relationship (skew between CLKB and CLKA) between the two scan chains 120a, 120b can be absorbed by FIFO150a. And, the number of clock cycles required for the transfer of the two scan chains 120a, 120b can be fixed by the counter circuit 160a. This allows the scan chains 120a, 120b to be synchronized even if the frequency of the CLOCK is increased (even if the CLOCK is sped up).

The FFB as the final stage flip-flop of the scan chain 120b on the input side of FIFO150a continues to write test data sent from FF2 as the previous stage flip-flop to FIFO150a every cycle. At this time, it is preferable to synchronize the writing from FFB to FIFO150a. For example, it is possible to synchronize only the writing of FFB and FIFO150a, or to include a circuit that transfers data by handshake between logic circuit 100a and logic circuit 100b. However, in that case, it is assumed that the throughput within one cycle of CLKA and CLKB is guaranteed.

The FFA as the first stage flip-flop of the scan chain 120a on the output side of FIFO150a continues to capture R_DATA read from FIFO150a. However, FIFO150a updates its top data (changes the pointer) only after the counter circuit 160a enables RD. Therefore, the R_DATA captured by FFA when RD is invalid is invalid.

For example, the counter circuit 160a may enable RD on the fourth cycle with respect to CLKA. In that case, FF3 starts outputting valid test data from the fifth cycle. The test data at this time is the data written from FF2 to FIFO150a in the first cycle.

This can be considered almost equivalent to the state (ATPG model) where FFB and FFA can transfer synchronously, with a structure in which a four-stage pipeline of FF is inserted between FFB and FFA, including FFB and FFA. However, the initial value of the FF pipeline is not exactly the same as that of FIFO150a. Create a test pattern for this ATPG (Automatic Test Pattern. Generation) model (ATPG_M). Then, use the created test pattern in a real circuit with FIFO150a and counter circuit 160a. This allows for faster scan testing.

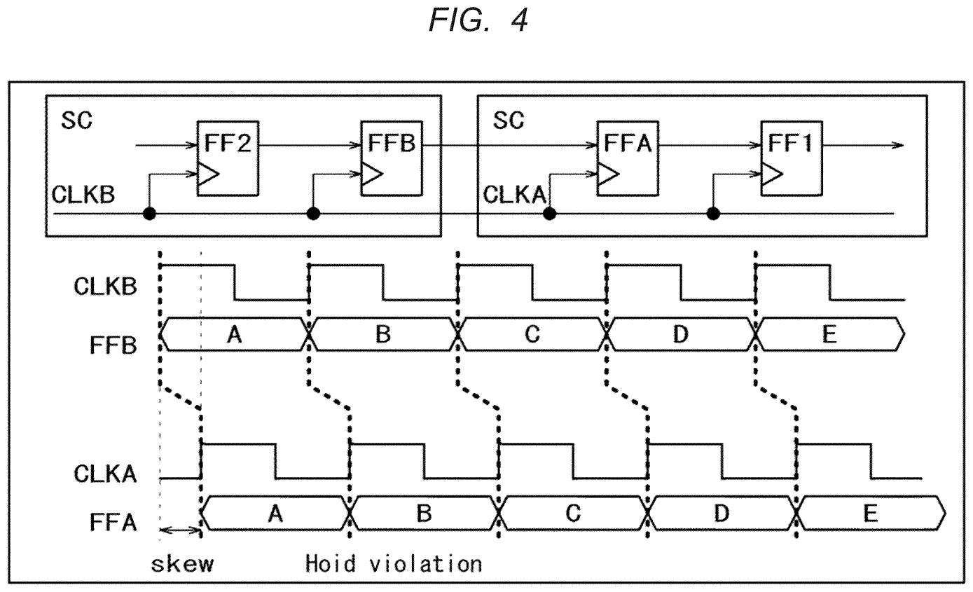

The effects of the embodiment will be explained using FIGS. 4 to 7.

When the scan test is performed across transfers between semiconductor chips, as shown in FIG. 4, a large clock skew (skew) occurs between the final stage flip-flop (FFB) of the scan chain 120b and the first stage flip-flop (FFA) of the scan chain 120a. This may prevent normal transfer due to a hold violation. In FIG. 4, an example of a clock skew of about ¼ clock cycle is shown.

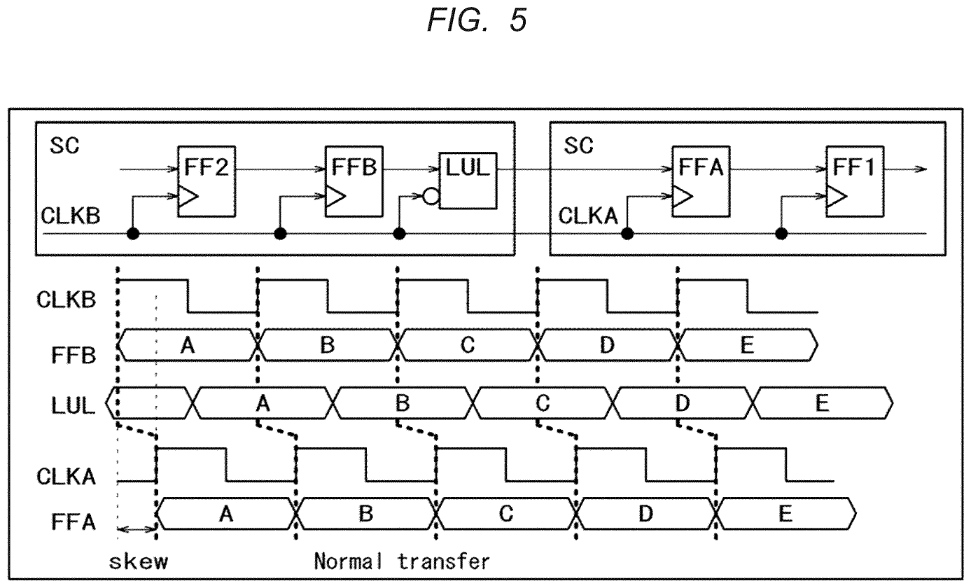

As a countermeasure, as shown in FIG. 5, a lock-up latch (LUL) is inserted between this FFB and FFA, and the transfer data from FFB is delayed by half a clock cycle and propagated to FFA. This enables synchronous transfer in semiconductor chip-to-chip transfer, allowing for normal transfer.

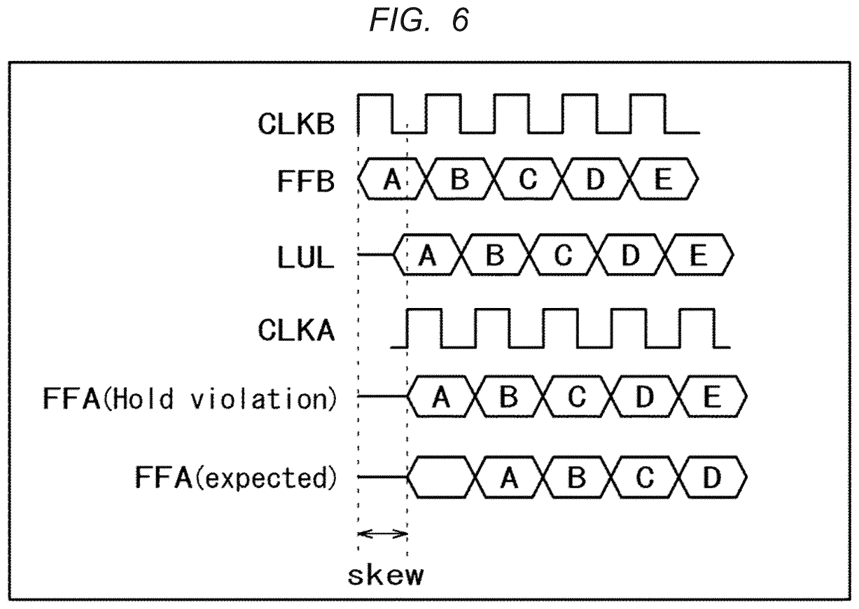

With the aim of reducing test costs, there is a demand for speeding up the clock of the scan test to shorten the test time. However, even in a configuration using LUL for transfer between semiconductor chips, if the clock is sped up, as shown in FIG. 6, a hold violation may occur. This occurs when the clock skew (the timing difference between CLKA and CLKB) is longer than the rise time of the clock. In FIG. 6, an example of a clock skew of about ¾ clock cycle is shown. If there is a hold violation, the data of LUL is latched to FFA one clock cycle earlier than expected.

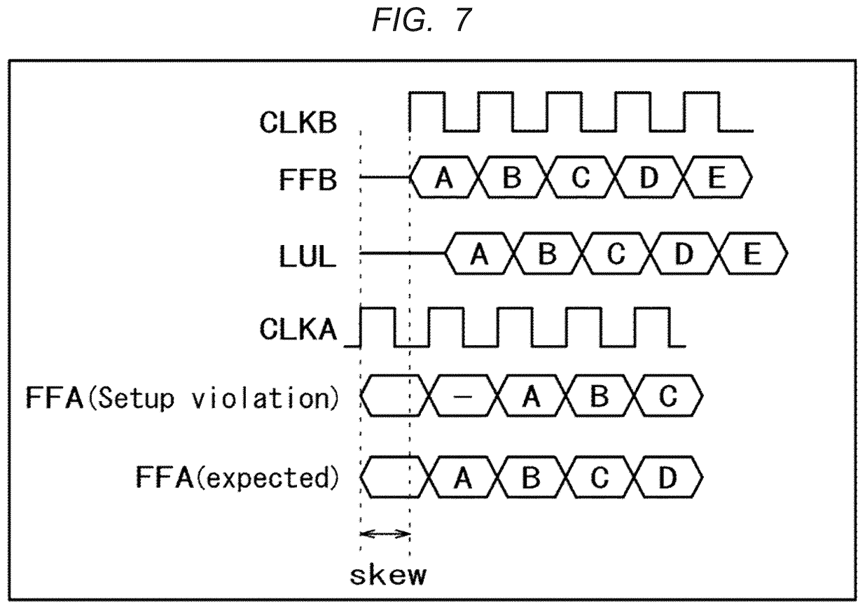

Furthermore, the problem of transfer between semiconductor chips is not limited to hold violations. There is also the issue of setup violations, that is, as shown in FIG. 7, the clock (CLKA) of the semiconductor chip on the input side that receives the scan data (output of LUL) of the semiconductor chip on the output side moves ahead of the arrival of the data, preventing normal transfer. In FIG. 7, an example of a clock skew of about ¾ clock cycles is shown. If there is a setup violation, the data of LUL is transferred one clock cycle later than expected to be latched onto FFA.

Aligning the clock latency of different semiconductor chips to eliminate skew requires a huge design cost and is realistically difficult, and if each semiconductor chip is developed at a different location and is a black box to each other, it can be said to be impossible. Whether a hold violation or a setup violation occurs, it can only be resolved by slowing down the clock. In other words, it is not possible to speed up the clock.

In this embodiment, as described above, it is possible to absorb the asynchronous relationship between the two scan chains 120a and 120b by the FIFO 150, and to fix the number of clock cycles required for the transfer of the two scan chains 120a and 120b by the counter circuit 160a. This makes it possible to synchronize the scan chains 120a and 120b even if the frequency of the CLOCK is increased (even if the CLOCK is sped up).

Hereinafter, more specific embodiments will be exemplified. In the description of the following embodiments, the same reference numerals as those used in the summary of the above embodiment may be used for parts having the same configuration and function as those described in the summary of the above embodiment. The description of such parts may be appropriately incorporated within the scope of technical consistency with the description in the summary of the above embodiment. Also, part of the summary of the above embodiment, and all or part of multiple embodiments, can be appropriately and collectively applied within the scope of technical consistency.

### First Embodiment

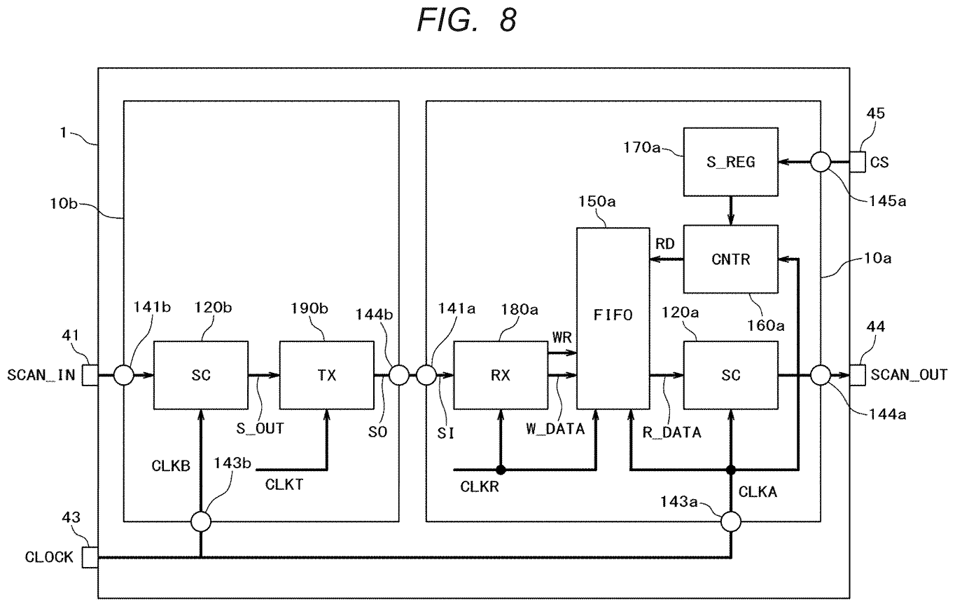

The semiconductor device in the first embodiment will be described using FIG. 8.

The semiconductor device 1 includes a semiconductor chip 10a as a first semiconductor circuit and a semiconductor chip 10b as a second semiconductor circuit. The semiconductor device 1 further includes an external terminal 41 where SCAN_IN is input, an external terminal 43 where CLOCK is input, an external terminal 44 where SCAN_OUT is output, and an external terminal 45 where a control signal (CS) is input. The semiconductor device 1 also includes an external terminal for inputting SCAN_EN similar to the external terminal 42 of the semiconductor device shown in FIG. 1, but the description thereof is omitted.

The semiconductor chip 10a includes a scan chain 120a, a FIFO 150a, a counter circuit 160a, a setting register (S_REG) 170a, and a receiving circuit (RX) 180a. The semiconductor chip 10a further includes terminals 141a, 143a, 144a, and 145a as input terminals. The output signal (SO) from the semiconductor chip 10b is input as an input signal (SI) to the terminal 141a. CLOCK from the external terminal 43 is input as CLKA to the terminal 143a. SCAN_OUT from the scan chain 120a is output from the terminal 144a. CS from the external terminal 45 is input to the terminal 145a. The setting register 170a holds the CS input from the terminal 145a. The semiconductor chip 10a also includes a terminal for inputting SCAN_EN similar to the external terminal 142 of the semiconductor chip shown in FIG. 1, but the description thereof is omitted.

The semiconductor chip 10b includes a scan chain 120b and a transmission circuit (TX) 190b. The semiconductor chip 10b further includes a terminal 141b where SCAN_IN from the external terminal 41 is input, a terminal 143b where CLOCK from the external terminal 43 is input as CLKB, and a terminal 144b as an output terminal where SO from the transmission circuit 190b is output. The SO includes test data from the test device 2 and scan test results from the scan chain 120b. The semiconductor chip 10b is equipped with a terminal into which SCAN_EN is input, similar to the external terminal 142 of the semiconductor chip shown in FIG. 1, but the description is omitted.

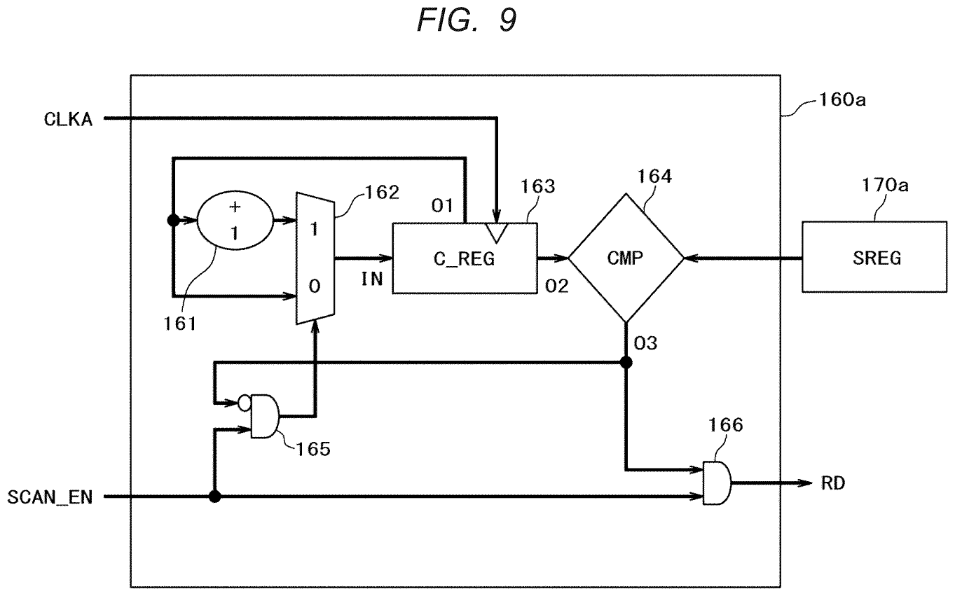

An example of the configuration of the counter circuit 160a will be explained using FIG. 9.

The counter circuit 160a includes an incrementer 161, a selector 162, a counter register (C_REG) 163, a comparator (CMP) 164, and AND circuits 165, 166. The counter circuit 160a starts counting with SCAN_EN as a trigger (here, a change from 0 to 1). When the value of the counter register 163 matches the value of the setting register 170a, it is configured to stop counting. Also, the counter circuit 160a is configured to enable RD and start reading from FIFO150a.

When SCAN_EN indicates “0”, which is invalid, the output signal of AND circuit 165 becomes “0”, and the selector 162 selects the output signal (O1) of the counter register 163. As a result, the input signal (IN) of the counter register 163 becomes O1, the value of the counter register 163 does not change, and the output signals (O1, O2) of the counter register 163 also do not change. As a result, the output signal (03) of the comparator 164 also does not change, and continues to output “0”, which indicates a mismatch. Also, when SCAN_EN is “0”, the output signal RD of AND circuit 166 indicates “0”, which is invalid.

When SCAN_EN indicates “1”, which is valid, and the output signal of the comparator 164 indicates a mismatch “0”, the output signal of the AND circuit 165 becomes “1”, and the selector 162 selects the output signal of the incrementer 161. As a result, the input signal (IN) of the counter register 163 becomes a value incremented by +1 from the value of O1, and the value of the counter register 163 becomes a value incremented by +1. As a result, the values of O1 and O2 also become values incremented by +1. The counter register 163 is counted up until its value matches the value of the setting register 170a. When the output signal of the comparator 164 indicates a match “1”, RD, which is the output signal of the AND circuit 166, becomes “1”, which indicates validity, because SCAN_EN is “1”. Also, when the output signal of the comparator 164 indicates a match “1”, the output signal of the AND circuit 165 becomes “0”, and the selector 162 selects O1 of the counter register 163. As a result, the value of the counter register 163 does not change, just like when SCAN_EN is “0”. The value of the counter register 163 at this time has become the set value of the setting register 170a+1.

The comparator 164 may have a fixed set value as the comparison target without using the setting register 170a. Although an example of an up counter was explained as the counter circuit 160a, the counter method is not limited, and any cycle can be counted, for example, it may be a down counter.

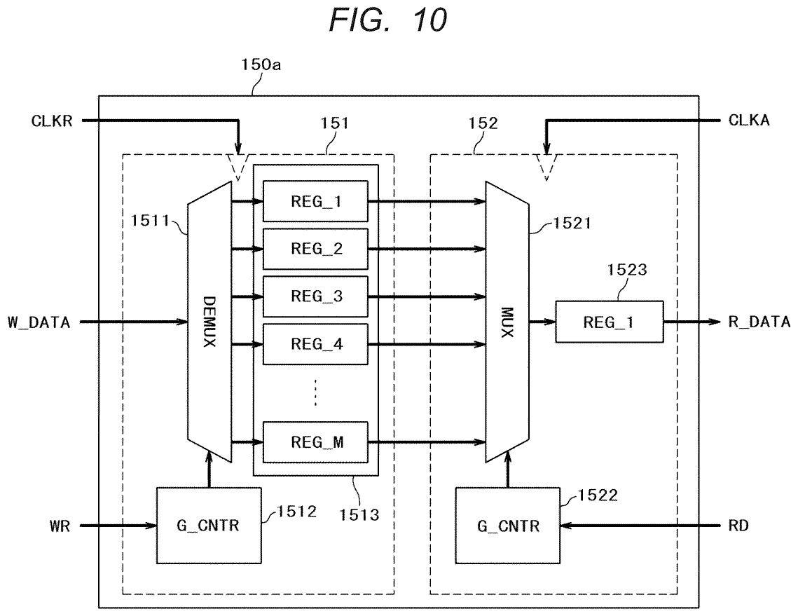

An example of the configuration of FIFO150a will be explained using FIG. 10.

FIFO150a includes a write circuit 151 that operates in synchronization with CLKR, and a read circuit 152 that operates in synchronization with CLKA. The write circuit 151 includes a demultiplexer (DEMUT) 1511, a gray code counter (G_CNTR) 1512, and a group of registers 1513. The group of registers 1513 is from REG_1 to REG_M. The read circuit 152 includes a multiplexer (MUX) 1521, a gray code counter (G_CNTR) 1522, and a register (REG) 1523.

The gray code counter 1512 changes the count value every time CLKR changes when the write signal (WR) is valid. The count value is expressed in binary, and changes so that there is only one bit change between adjacent values. The demultiplexer 1511 selects a register corresponding to the count value of the gray code counter 1512 from the group of registers 1513, and the write data (W_DATA) is written to the selected register. The registers of the register group 1513 are selected in order from PEG_1 to REG_M.

The gray code counter 1522 changes the count value every time CLKA changes when RD is valid. The multiplexer 1521 selects a register corresponding to the count value of the gray code counter 1522 from the group of registers 1513, and the value of the selected register is read out to the register 1523. The registers of the register group 1513 are selected in order from REG_1 to REG_M. The data stored in register 1523 is output to the scan chain 120a as R_DATA.

The counter circuit used in the write circuit 151 and the read circuit 152 is not limited to a gray code counter, but may be a binary code counter.

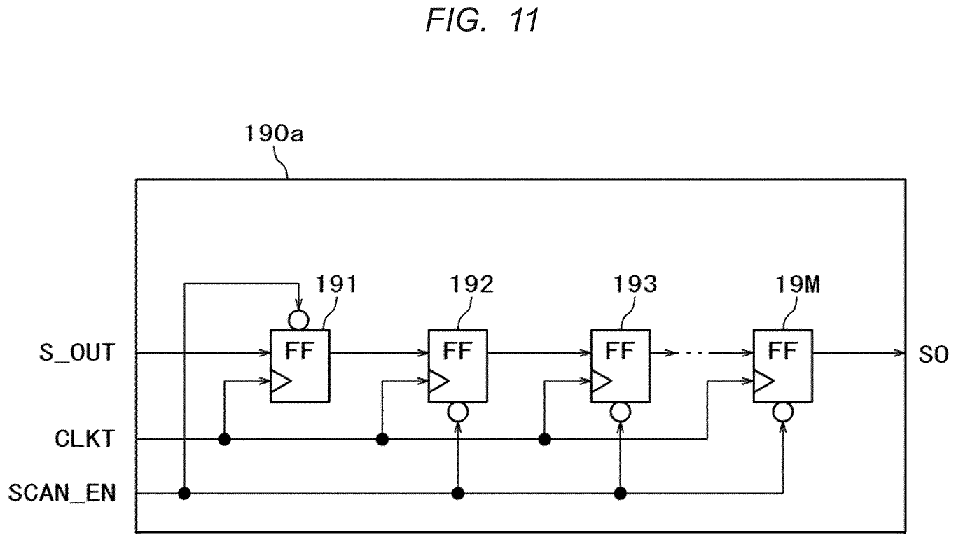

An example of the configuration of the transmission circuit 190a will be explained using FIG. 11.

The transmission circuit 190a includes a shift register composed of M flip-flops from FF191 to FF19M. Here, M is an integer of 3 or more. FF191 to FF19M are flip-flops that capture data signals in synchronization with the rising edge of CLKT as the fourth clock signal. FF191 is set (“1”) when SCAN_EN becomes valid, and FF192 to FF19M are reset (“0”) when SCAN_EN becomes valid. The output signal (S_OUT) of the scan chain 120b is input to FF191.

When SCAN_EN becomes valid, the transmission circuit 190a outputs (M−1) consecutive “0”s, and then outputs “1” for one cycle as the output signal (SO). This single cycle “1” is a flag indicating the beginning of the test data. After that, S_OUT is sequentially transmitted as SO.

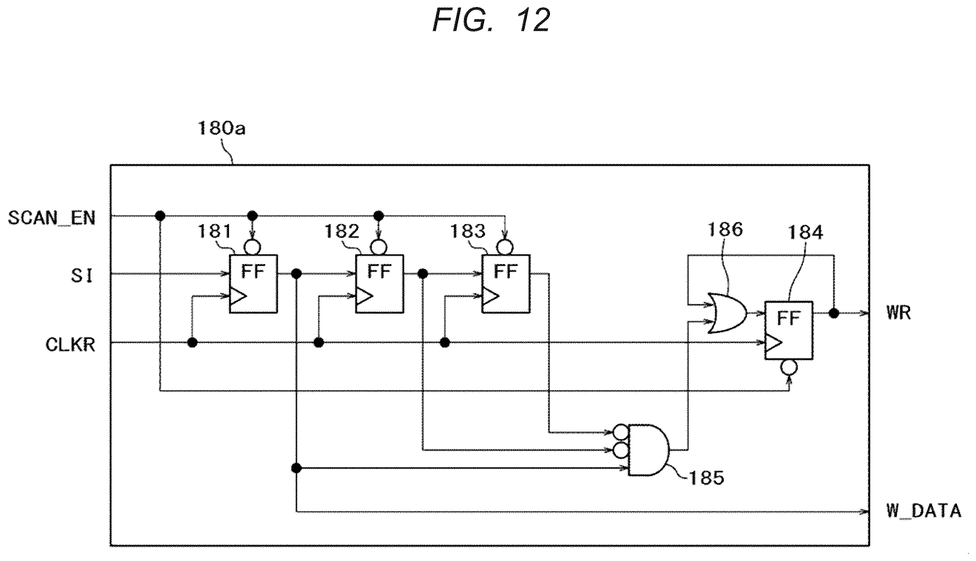

An example of the configuration of the reception circuit 180a will be explained using FIG. 12. FIG. 12 is a block diagram showing an example of the configuration of the reception circuit shown in FIG. 8.

The reception circuit 180a includes a shift register composed of FF181, FF182, FF183, FF184, an AND circuit 185, and an OR circuit 186. FF181, FF182, FF183, and FF184 are flip-flops that capture data signals in synchronization with the rising edge of CLKR. FF1l1, FF182, FF183 are set (“1”) when SCAN_EN becomes valid, and FF184 is reset (“0”) when SCAN_EN becomes valid. The SO from the transmission circuit 190a is input to FF181 as the input signal (SI).

The AND circuit 185 becomes “1” when “1” is input after consecutive “0”s as SI. The output of the AND circuit 185 is input to FF184 via the OR circuit 186, and FF184 becomes “1”, and WR becomes valid. After that, the output of the AND circuit 185 becomes “0”, but since the output of FF184 is input to FF184 via the OR circuit 186, FF184 retains “1”.

When the reception circuit 180a detects “1” after consecutive “0”s, it makes WR valid. It adjusts so that the data after the detected “1” after consecutive “0”s is output as W_DATA in sync with the cycle when WR becomes valid.

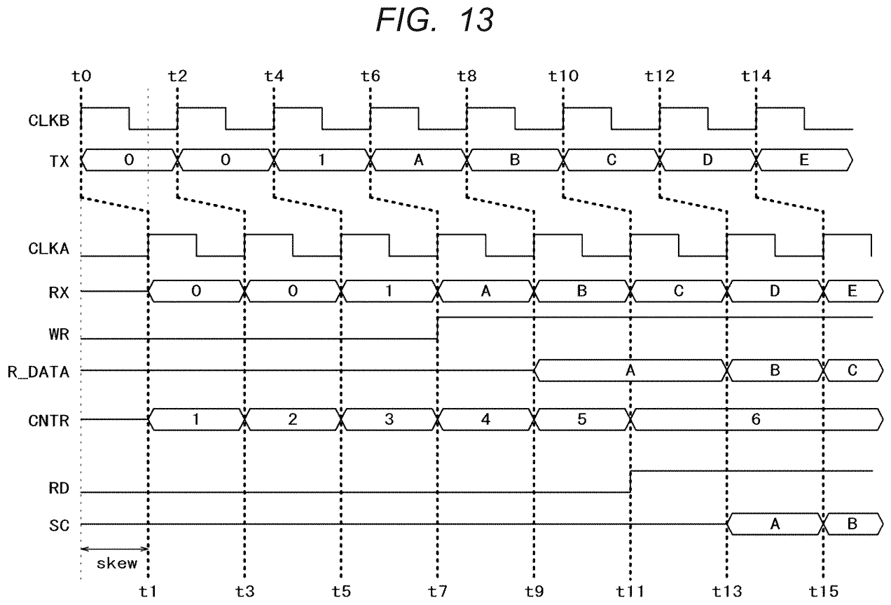

The operation of the transmission circuit 190a, the reception circuit 180a, the FIFO 150a, and the counter circuit 160a will be explained using FIG. 13.

CLKT is approximately the same phase as CLKB, and CLKR is approximately the same phase as CLKA, so they are omitted. The timing of the rising edge of CLKB is t0, t2, t4, . . . , t14. The timing of the rising edge of CLKA is t1, t3, t5, . . . , t15. In FIG. 13, an example where the clock skew (t1−t0) of CLKB and CLKA is about ¾ clock cycles is shown.

The transmission circuit 190a outputs “0” at t0, “0” at t2, “1” at t4, and then outputs “A”, “B”, “C”, “D”, “E” as test data at t6, t8, t10, t12, t14.

The reception circuit 180a inputs and outputs “0” at t1, “0” at t3, “1” at t5, and then inputs and outputs “A” at t7, “B” at t9, “C” at t1l, “D” at t13, “E” at t15. The reception circuit 180a detects the “1” input at t5 and makes WP valid at t7.

FIFO 150a writes “A” to REG_1 due to the active WR at t7. After that, it writes “B” to REG_2 at t9, “C” to REG_3 at t11, and “D” to REG_4 at t13. The counter circuit 160a makes the counter register 163 “1” at t1, counts up every clock cycle, and when the counter register 163 becomes “6” at t1l, it makes RD valid.

FIFO 150a reads “A” from REG_1 due to the valid RD at t11. After that, it reads “B” from REG_2 at t13, and “C” from REG_3 at t15. The scan chain 120a inputs “A” at t13 and “B” at t15.

In the first embodiment, a transmission circuit 190b is provided after the scan chain 120b, and a reception circuit 180a is provided before the FIFO 150a. This allows for successful writing from scan chain 120b to FIFO 150a.

### Second Embodiment

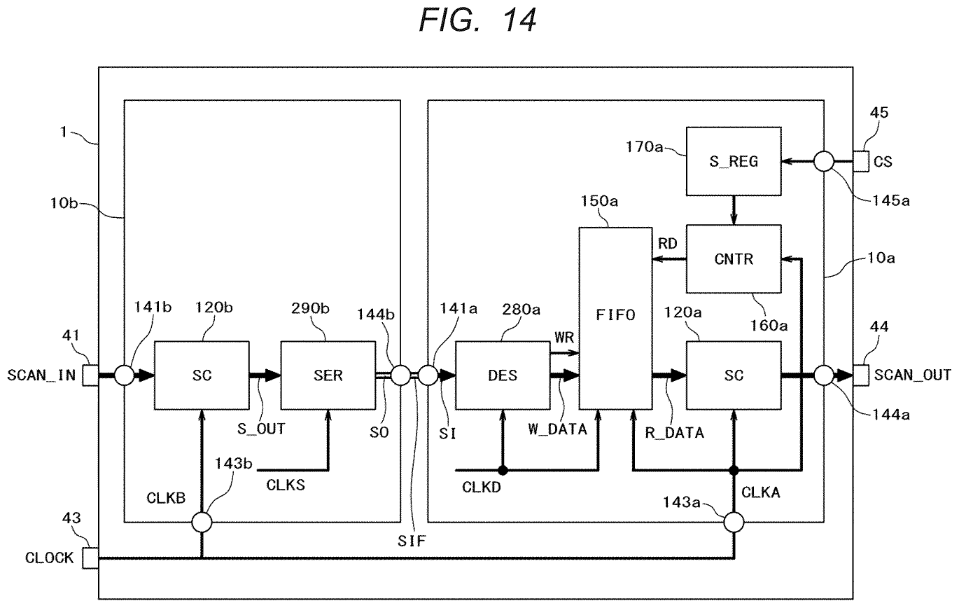

The semiconductor device in the second embodiment will be explained using FIG. 14.

The semiconductor device in the second embodiment is composed of test data of multiple bits (N bits, N>2), and is an example of transferring between semiconductor chips using a serializer and deserializer (Serializer/Deserializer: SerDes).

The semiconductor device 1 includes a semiconductor chip 10a as a first semiconductor circuit and a semiconductor chip 10b as a second semiconductor circuit. The semiconductor device 1 further includes an external terminal 41 where SCAN_IN is input, an external terminal 43 where CLOCK is input, an external terminal 44 where SCAN_OUT is output, and an external terminal 45 where CS is input. SCAN_IN is data of N-bit length, and there are N external terminals 41. There are N external terminals 43, and SCAN_OUT is data of N-bit length. Here, N is an integer of 2 or more. The semiconductor device 1 includes an external terminal where SCAN_EN is input, similar to the external terminal 42 of the semiconductor device shown in FIG. 1, but the description is omitted.

The semiconductor chip 10a includes a scan chain 120a, FIFO 150a, counter circuit 160a, setting register (S_REG) 170a as a register, and deserializer (DES) 280a as a receiving circuit. The semiconductor chip 10a further includes a terminal 141a where the output signal (SO) from the semiconductor chip 10b is input as an input signal (SI), a terminal 143a where CLOCK from the external terminal 43 is input as CLKA, a terminal 144a where SCAN_OUT from the scan chain 120a is output, and a terminal 145a where CS from the external terminal 45 is input. There are N terminals 144a. The semiconductor chip 10a includes a terminal where SCAN_EN is input, similar to the external terminal 142 of the semiconductor chip shown in FIG. 1, but the description is omitted.

The semiconductor chip 10b includes a scan chain 120b, a serializer (SER) 290b as a transmission circuit, a terminal 141b, a terminal 143b, and a terminal 144b. SCAN_IN from the external terminal 41 is input to the terminal 141b. CLOCK from the external terminal 43 is input as CLKB to the terminal 143b. SO from the serializer 290b is output from the terminal 144b. The serializer 290b and the deserializer 280a can be connected via the terminals 141b and 141a with a high-speed serial interface (SIF) of more than 1 gigabit per second (Gbps). The semiconductor chip 10b includes a terminal where SCAN_EN is input, similar to the external terminal 142 of the semiconductor chip shown in FIG. 1, but the description is omitted.

The scan chains 120a and 120b have the same configuration as the scan chains 120a and 120b shown in FIG. 8. However, in the scan chains 120a and 120b in this embodiment, data of N-bit length is input in parallel and output in parallel.

FIFO 150a has the same configuration as the FIFO 150a shown in FIG. 10. However, in the FIFO 150a in this embodiment, data of N-bit length is input in parallel and output in parallel. The write circuit 151 operates in synchronization with CLKD as the second clock signal. The read circuit 152 operates in synchronization with CLKA.

The counter circuit 160a has the same configuration as the counter circuit 160a shown in FIG. 9. The setting register 170a has the same configuration as the setting register 170a shown in FIG. 8.

The serializer 290b synchronizes with CLKS as the fourth clock signal to convert and output N-bit wide test data (S_OUT) into a continuous 1-bit serial data signal (SO). CLKS is a clock signal that multiplies CLKB. The deserializer 280a synchronizes with CLKD to convert and output a continuous 1-bit input signal (SI) into N-bit wide test data (W_DATA). CLKD is a clock signal that multiplies CLKA.

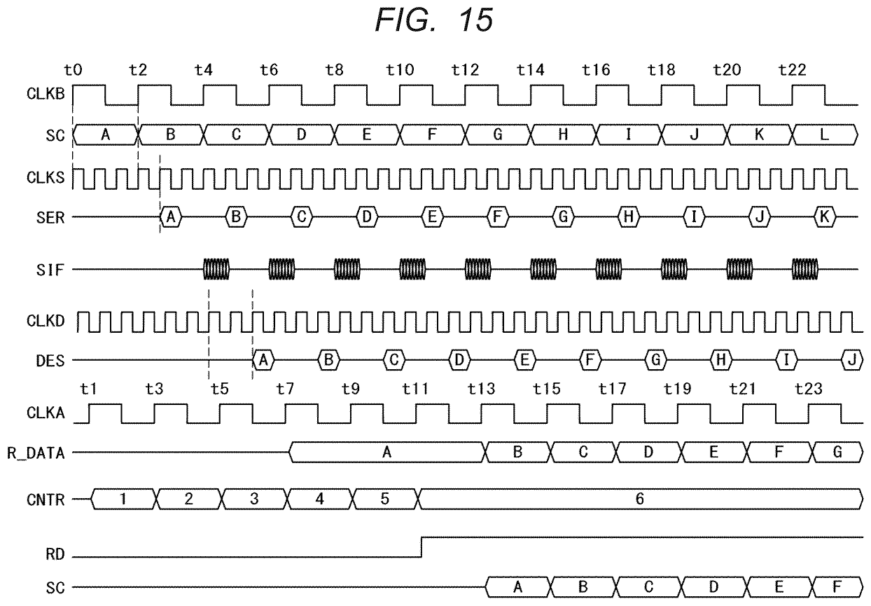

The operation of the serializer 290b, deserializer 280a, FIFO 150a, and counter circuit 160a will be explained using FIG. 15.

The rising timing of CLKB is t0, t2, t4, . . . , t22. The rising timing of CLKA is t1, t3, t5, . . . , t23. The clock skew (t1−t0) of CLKB and CLKA is shown as an example of about ¼ clock cycle. In FIG. 15, an example of a clock signal with a frequency three times (⅓ of the period) that of CLKB, denoted as CLKS, is shown. In FIG. 15, an example of a clock signal with a frequency three times (⅓ of the period) that of CLKA, denoted as CLKD, is shown.

The scan chain 120b outputs “A”, “B”, “C”, . . . , “L” as test data at t0, t2, t4, . . . , t20. The serializer 290b serializes “A” during the three clock cycles after one clock cycle of CLKS following the rise of t2. The serialized “A” is input to the deserializer 280a via the SIF.

The deserializer 280a inputs the first bit of the serialized “A” at the rise of CLKD, and inputs the remaining two bits of the serialized “A” during the next two clock cycles of CLKD to parallelize. WR is activated at a predetermined timing of parallelization.

FIFO150a writes “A” to REG_1 due to the activation of WR. The counter circuit 160a counts up by one clock cycle each time, with the counter register 163 becoming “1” at t1, and when the counter register 163 becomes “6” at t1l, RD is enabled.

FIFO150a reads “A” from REG_1 due to the activation of RD at t1l. Then, “B” is read from REG_2 at t13, and “C” is read from REG_3 at t15. The scan chain 120a inputs “A” at t13 and “B” at t15.

### Third Embodiment

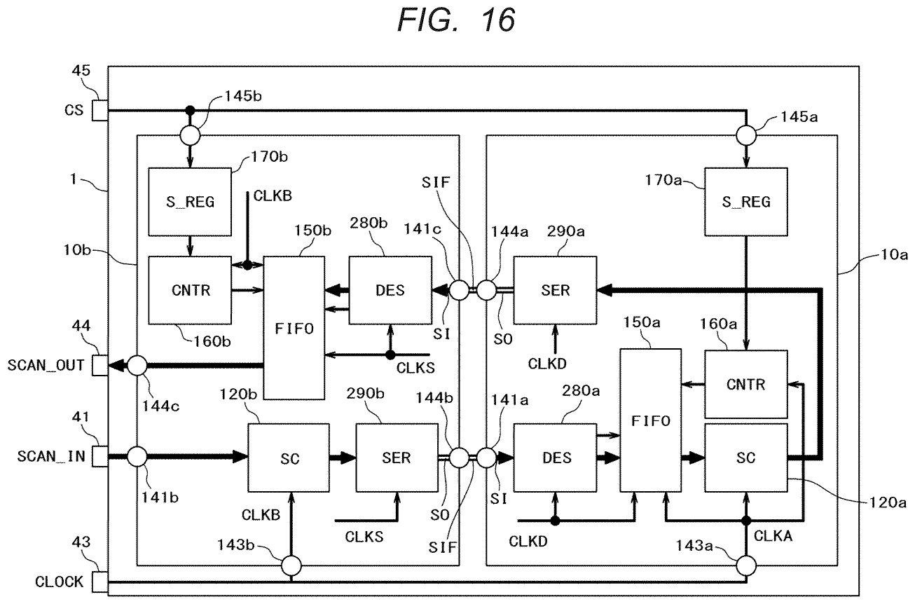

The semiconductor device in the third embodiment will be explained using FIG. 16.

The semiconductor device in the third embodiment is an example of sending test data from semiconductor chip 10b to semiconductor chip 10a, and then returning the test data sent to semiconductor chip 10a to semiconductor chip 10b.

The semiconductor chip 10a in the third embodiment further includes a serializer 290a as a transmission device compared to the semiconductor chip 10a in the second embodiment. The serializer 290a is arranged between the scan chain 120a and the terminal 144a. Note that the terminal 144a is one, unlike the third embodiment.

The semiconductor chip 10b in the third embodiment further includes a FIFO150b as a buffer, a counter circuit 160b, a setting register 170b, and a deserializer (DES) 280b as a receiving circuit compared to the semiconductor chip 10b in the second embodiment. The semiconductor chip 10b further includes a terminal 141c where the output signal (SO) from the semiconductor chip 10a is input as an input signal (SI), a terminal 144c where SCAN_OUT from FIFO150b is output, and a terminal 145b where CS from the external terminal 45 is input. The serializer 290a and the deserializer 280b can be connected via a high-speed serial interface (SIF) through the terminals 144a and 141c.

FIFO150b has the same configuration as FIFO150a. The write circuit 151 operates in synchronization with CLKS as the fourth clock signal. The read circuit 152 operates in synchronization with CLKB.

The counter circuit 160b has the same configuration as the counter circuit 160a. The setting register 170b has the same configuration as the setting register 170a.

The serializer 290a converts and outputs N-bit wide test data (S_OUT) into a continuous 1-bit serial data signal (SO) in synchronization with CLKD as the second clock signal. CLKS is a clock signal that is a multiple of CLKB. The deserializer 280b converts and outputs a continuous 1-bit input signal (SI) into N-bit wide test data (W_DATA) in synchronization with CLKS. CLKS is a clock signal that is a multiple of CLKB.

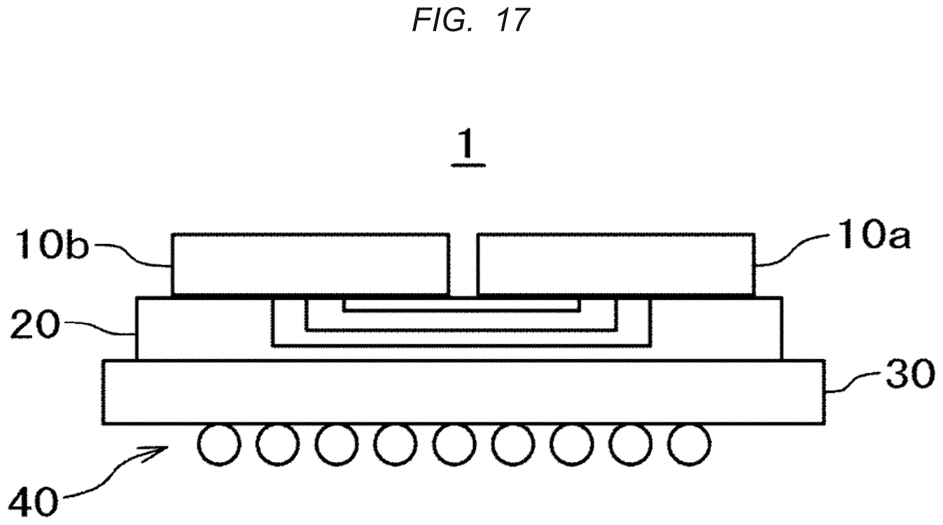

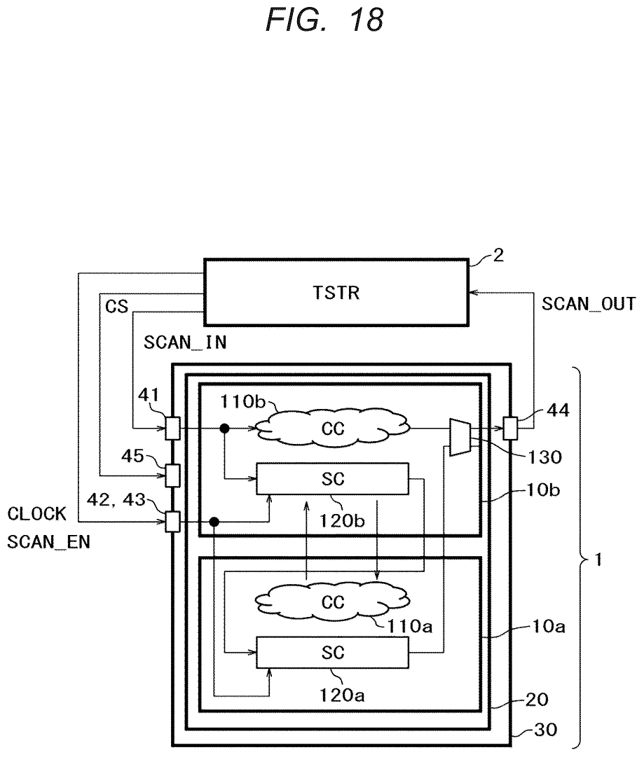

Next, the scan test of the semiconductor device in this embodiment will be explained using FIGS. 17 and 18.

As shown in FIG. 17, the semiconductor device 1 in this embodiment includes semiconductor chips 10a, 10b, a silicon interposer 20, and a package substrate 30. The silicon interposer 20 has wiring that connects the terminals of the semiconductor chip 10a and the terminals of the semiconductor chip 10b, and wiring that connects the terminals of the semiconductor chip 10b and the package substrate 30. On the upper surface of the package substrate 30, a wiring is provided that is electrically connected to the terminals of the semiconductor chip 10b via the wiring of the silicon interposer 20. On the lower surface of the package substrate 30, a plurality of external terminals 40 that are electrically connected to the terminals of the semiconductor chip 10b are connected.

As shown in FIG. 18, the semiconductor chip 10a has a combination circuit 110a and a scan chain 120a. The semiconductor chip 10b has a combination circuit 110b, a scan chain 120b, and a multiplexer 130. The plurality of external terminals 40 include external terminals 41, 42, 43, 44, 45. In FIG. 18, other components shown in FIG. 16 are omitted, so they will be described with reference to FIG. 16 as appropriate.

SCAN_IN from the test device 2 is input to the N external terminals 41 and is input to the scan chain 120b via the N terminals 141b (see FIG. 16) of the semiconductor chip 10b. SCAN_EN from the test device 2 is input to the external terminal 42 and is input to the scan chain 120b via the terminal 142b of the semiconductor chip 10b. CLOCK from the test device 2 is input to the external terminal 43 and is input to the scan chain 120b via the terminal 143b (see FIG. 16) of the semiconductor chip 10b. CS from the test device 2 is input to the external terminal 45 and is input to the setting register 170b via the terminal 145b (see FIG. 16) of the semiconductor chip 10b.

The output signal of the scan chain 120b is output from the terminal 144b (see FIG. 16) and is input to the scan chain 120a as an input signal via the terminal 141a (see FIG. 16) of the semiconductor chip 10a. The SCAN_EN input via the terminal 142b of the semiconductor chip 10b is input to the scan chain 120a via the terminal 142a of the semiconductor chip 10a. The CLOCK input via the terminal 143b (see FIG. 16) of the semiconductor chip 10b is input to the scan chain 120a via the terminal 143a (see FIG. 16) of the semiconductor chip 10a.

The output signal of the scan chain 120a is output from the terminal 144a (see FIG. 16), and is output from the N external terminals 44 via the terminal 141c of the semiconductor chip 10b, the deserializer 280b, the FIFO 150b, the multiplexer 130, and the N terminals 144c.

The scan chain 120a of the semiconductor chip 10a is connected to the scan chain 120b of the semiconductor chip 10b, and a scan test is performed via the semiconductor chip 10b. Also, the semiconductor chip 10a performs input and output of test data via the semiconductor chip 10b connected to the external terminal 40. As a result, the semiconductor chip 10a can perform a scan test even if it does not require external terminals or if it is connected to fewer terminals than the number of external terminals required for the scan test.

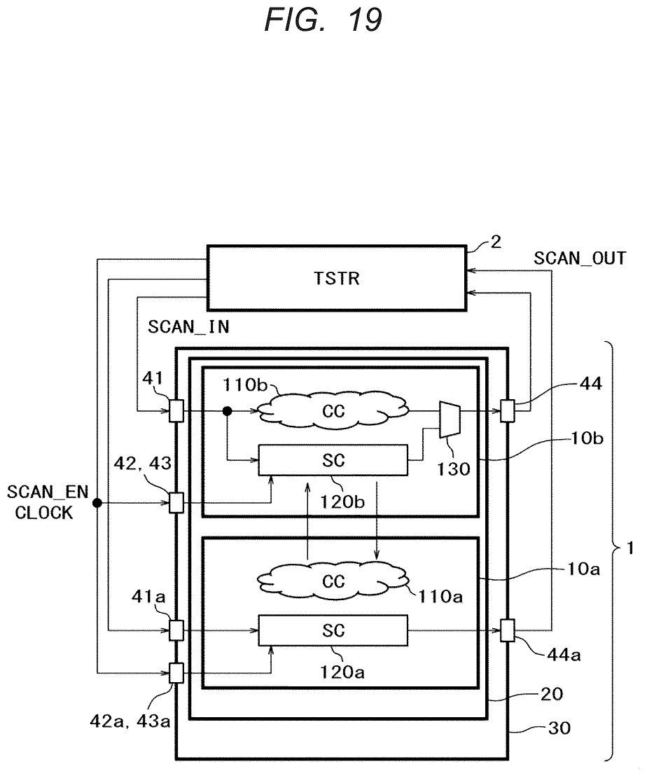

Other effects of the semiconductor device 1 in the third embodiment will be explained using FIG. 19.

It is possible to perform a scan test of the semiconductor chip 10a by providing external terminals 41a, 42a, 43a, 44a dedicated to the scan test on the semiconductor chip 10a. However, the number of external terminals 40 will increase by (2N+2) compared to this embodiment. In other words, according to this embodiment, it is possible to suppress an increase in external terminals.

### Fourth Embodiment

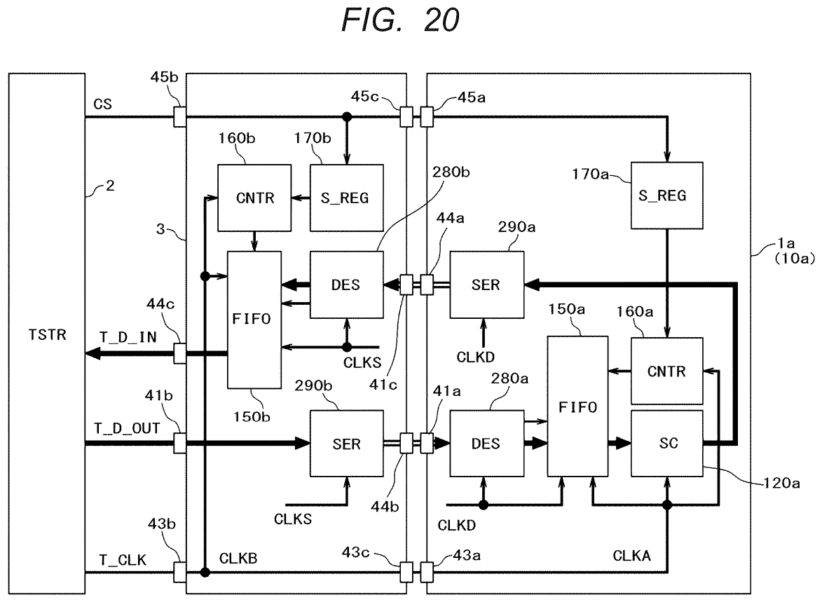

The semiconductor diagnostic device in the fourth embodiment will be explained using FIG. 20.

The semiconductor diagnostic device in the fourth embodiment is an example of a device for diagnosing the semiconductor device 1a composed of the semiconductor chip 10a in the third embodiment. The semiconductor diagnostic device includes a test device 2 and a second test device 3.

The second test device 3 is configured without the scan chain 120b and the test target combination circuit 110b from the semiconductor chip 10b in the third embodiment. The second test device 3 includes external terminals 41b, 43b, 44b, 45b, 41c, 44c corresponding to the terminals 141b, 143b, 144b, 145b, 141c, 144c of the semiconductor chip 10b in the third embodiment. Test data output (T_D_OUT) is input from the test device 2 to the external terminal 41b, test clock (T_CLK) is input to the external terminal 43b, and CS is input from the external terminal 45b. The test data input (T_D_IN) output from the external terminal 44c is input to the test device 2.

In this embodiment, the semiconductor device 1a is equipped with external terminals 41a, 43a, 44a, 45a corresponding to the terminals 141a, 143a, 144a, 145a of the semiconductor chip 10a in the third embodiment. The semiconductor device 1a is connected to the second test device 3 in the same way as the semiconductor chips 10a, 10b in the third embodiment.

The test device 2 can test (diagnose) the semiconductor device 1a without going through the scan chain 120b of the semiconductor chip 10b in the third embodiment.

### Fifth Embodiment

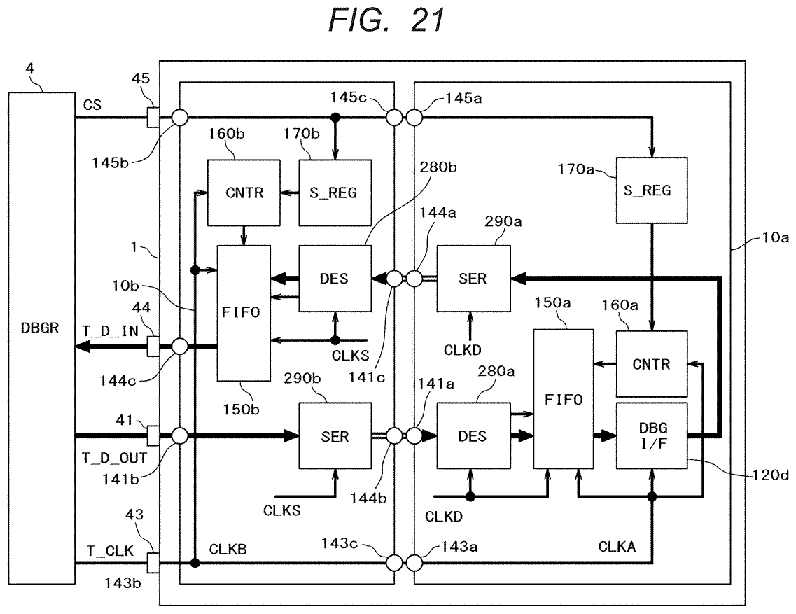

The semiconductor device in the fifth embodiment will be described using FIG. 21.

The semiconductor device in the fifth embodiment is an example where the scan chain 120a of the semiconductor chip 10a in the third embodiment is replaced with a debug interface (DBGI/F) 120d.

In this embodiment, the semiconductor device 1 includes a semiconductor chip 10a as a first semiconductor circuit and a semiconductor chip 10b as a second semiconductor circuit. The semiconductor chip 10b in this embodiment is configured without the scan chain 120b and the combination circuit 110b to be tested from the semiconductor chip 10b in the third embodiment.

Test data input (T_D_IN) is input to the external terminal 41 from the debugger device 4, test clock (T_CLK) is input to the external terminal 43, and CS is input from the external terminal 45. Test data output (T_D_OUT) is output from the external terminal 44 and input to the debugger device 4.

The debugger device 4 can debug the semiconductor chip 10a without going through the scan chain 120b of the semiconductor chip 10b in the third embodiment and the scan chain 120a of the semiconductor chip 10a.

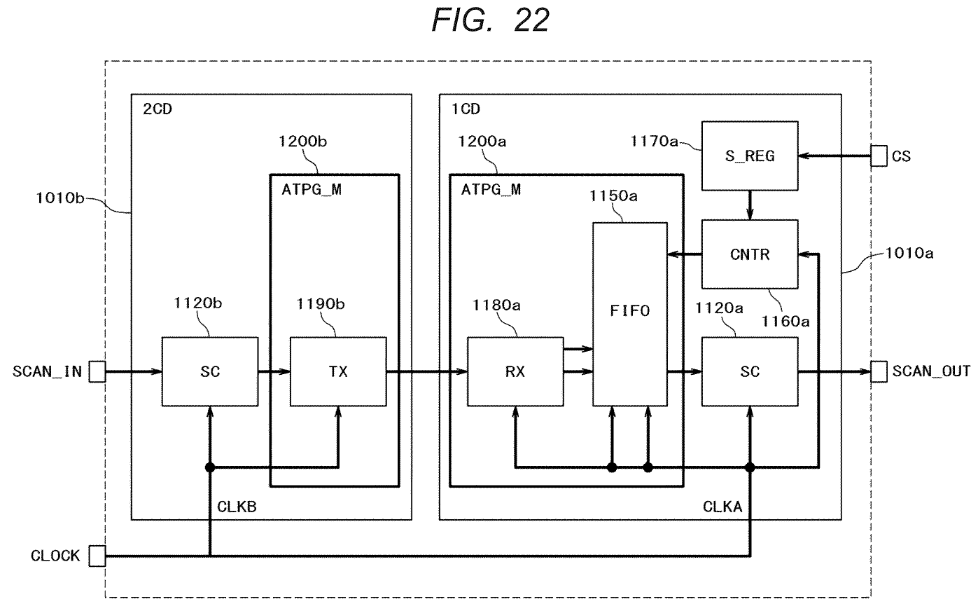

The test pattern generation and diagnosis of the semiconductor device in the first embodiment will be explained using FIGS. 22 to 25.

As shown in FIG. 22, the circuit data of the semiconductor device 1 includes the first circuit data (1CD) 1010a and the second circuit data (2CD) 1010b. The first circuit data 1010a is the circuit data of the semiconductor chip 10a. The second circuit data 1010b is the circuit data of the semiconductor chip 10b.

The first circuit data (1CD) 1010a includes the circuit data 1120a of the scan chain 120a, the circuit data 1150a of the FIFO 150a, the circuit data 1160a of the counter circuit 160a, the circuit data 1170a of the setting register 170a, and the circuit data 1180a of the receiving circuit 180a. The circuit data 1150a and the circuit data 1180a are modules (ATPG_M) 1200a to be replaced with the ATPG model.

The second circuit data (2CD) 1010b has the circuit data 1120b of the scan chain 120b and the circuit data 1190b of the transmission circuit 190b. The circuit data 1190b is a module (ATPG_M) 1200b to be replaced with the ATPG model.

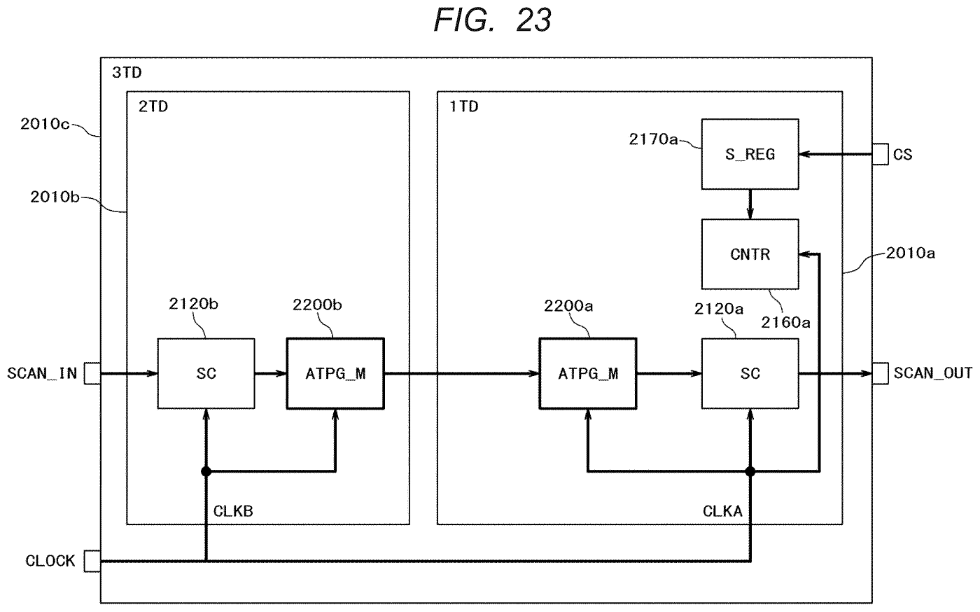

As shown in FIG. 23, the test design data of the semiconductor device 1 includes the first test design data (1TD) 2010a, the second test design data (2TD) 2010b, and the third test design data (3TD) 2010c. The first test design data (1TD) 2010a is the design data for generating test patterns of the semiconductor chip 10a. The second test design data (2TD) 2010b is the design data for generating test patterns of the semiconductor chip 10b. The third test design data (3TD) 2010c is the design data for generating test patterns of the semiconductor device 1.

The first test design data (1TD) 2010a includes the test design data 2120a of the scan chain 120a, the test design data 2160a of the counter circuit 160a, the test design data 2170a of the setting register 170a, and the test design data 2200a of the ATPG_M 2000a.

The second test design data (2TD) 2010b includes the test design data 2120b of the scan chain 120b and the test design data 2200b of the ATPG_M 2000b.

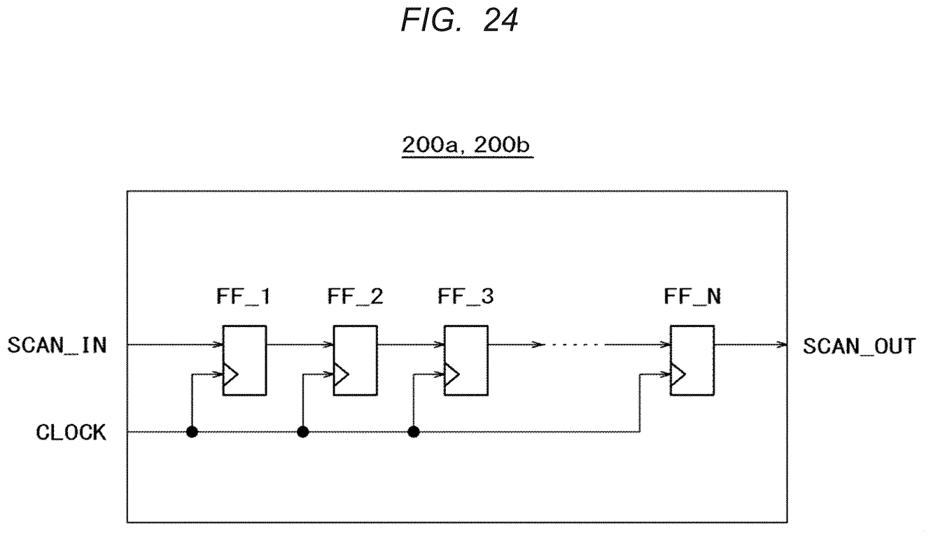

As shown in FIG. 24, ATPG_M 2000a, 2000b form a shift register of N stages by N FFs (FF_1, FF_2, FF_3, . . . , FF_N).

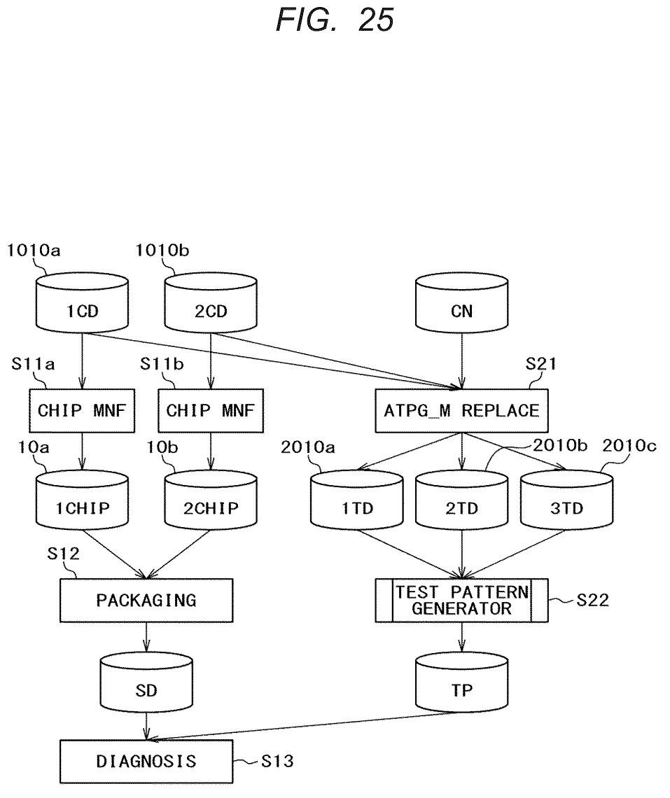

As shown in FIG. 25, the semiconductor chip (1CHIP) 10a is manufactured based on the first circuit data 1010a (step S11a). The semiconductor chip (1CHIP) 10b is manufactured based on the second circuit data 1010b (step S11b). The semiconductor chips 10a and 10b are packaged to manufacture a semiconductor device (SD) (step S12).

Replace ATPG_M 2000a and ATPG_M 2000b of the first circuit data 1010a and the second circuit data 1010b with ATPG, and generate the count number (CN) first test design data 2010a, second test design data 2010b, and third test design data 2010c (step 321). Generate test patterns (TP) based on the first test design data 2010a, the second test design data 2010b, and the third test design data 2010c by a test pattern generation tool (step S22).

Diagnose the semiconductor device (SD) with the test pattern (TP) (step S13).

Although the disclosure made by the present inventors has been specifically described based on the embodiments, it goes without saying that the present disclosure is not limited to the above embodiments and can be variously modified.

What is claimed is:

1. A semiconductor device comprising:
a first semiconductor circuit having a counter circuit configured to count in synchronization with a first clock signal and generate a readout signal when the count reaches a predetermined number;
a buffer configured to store test data and sequentially output the test data in the order stored in synchronization with the first clock signal when the readout signal indicates a valid value; and
a first scan test circuit configured to sequentially capture the test data output from the buffer in synchronization with the first clock signal.

2. The semiconductor device according to claim 1,
wherein the counter circuit includes:
a counter register that counts up, counts down, or makes a regular change similar to these in synchronization with the first clock signal; and
a comparator that determines the match and mismatch between the value of the counter register and the predetermined number,
wherein the semiconductor device is configured to perform a count operation when the scan enable is valid and the comparator indicates a mismatch, and is configured to enable the readout signal when the scan enable is valid and the comparator indicates a match, the semiconductor device.

3. The semiconductor device according to claim 1, comprising a setting register capable of setting any value from outside the semiconductor device for the predetermined number, the semiconductor device.

4. The semiconductor device according to claim 2,
wherein the buffer includes a plurality of registers for storing the test data, and is configured to read out the test data from the register in which the earliest valid data is stored in synchronization with the first clock signal when the readout signal is valid, and to write the test data into an empty register among the plurality of registers in synchronization with a second clock signal when a write signal is valid.

5. The semiconductor device according to claim 1 further comprising a second semiconductor circuit,
wherein the first semiconductor circuit further includes an input terminal and a receiving circuit that sequentially writes the test data input to the input terminal into the buffer in synchronization with a second clock signal, and
wherein the second semiconductor circuit includes a second scan test circuit that captures test data input from outside in synchronization with a third clock signal, an output terminal, and a transmission circuit that outputs the test data output by the second scan test circuit to the output terminal in synchronization with a fourth clock signal, and
wherein the input terminal is connected to the output terminal.

6. The semiconductor device according to claim 5,
wherein the transmission circuit is configured to output a flag indicating that the next data is the beginning of the test data to the output terminal, and then sequentially output the test data output by the second scan test circuit to the output terminal, and
wherein the receiving circuit is configured to detect the flag input from the input terminal, enable the write signal, and sequentially output the test data input from the input terminal to the buffer.

7. The semiconductor device according to claim 5,
wherein the first scan test circuit has N-bit (N is an integer of 2 or more) input/output,
wherein the buffer has N-bit input/output for storing the test data of the first scan test circuit,
wherein the receiving circuit is a deserializer that converts a 1-bit continuous input signal into N-bit test data and outputs it,
wherein the second scan test circuit has N-bit input/output,
wherein the transmitting circuit is a serializer that converts N-bit test data into a 1-bit continuous serial data and outputs it, and
wherein the serial data is configured to be transferred to the receiving circuit via a high-speed serial I/F.

8. The semiconductor device according to claim 5,
wherein the first semiconductor circuit further includes an output terminal and a transmitting circuit that outputs the test data output by the first scan test circuit to the output terminal in synchronization with the second clock signal,
wherein the second semiconductor circuit further includes:
a counter circuit configured to count in synchronization with the third clock signal and generate a read signal when the count number reaches a predetermined number;
a buffer configured to store test data and sequentially output the test data in synchronization with the third clock signal when the read signal indicates a valid value;
an input terminal; and
a receiving circuit configured to sequentially write the test data received at the input terminal into the buffer in synchronization with the fourth clock signal.

9. The semiconductor device according to claim 8,
wherein the first scan test circuit has N-bit (N is an integer of 2 or more) input and output,
wherein the buffer has N-bit input and output that store the test data of the first scan test circuit,
wherein the receiving circuit is a deserializer that converts a 1-bit continuous input signal into N-bit test data and outputs it,
wherein the second scan test circuit has N-bit input and output,
wherein the transmitting circuit is a serializer that converts N-bit test data into a 1-bit continuous signal and outputs it, and
wherein the serializer is configured to transfer the 1-bit continuous signal to the deserializer via a high-speed serial interface circuit.

10. A semiconductor diagnostic device that diagnoses a first semiconductor circuit, comprising:
a counter circuit configured to count in synchronization with a first clock signal and generate a readout signal when the count reaches a predetermined number;
a buffer configured to store test data and sequentially output the test data in the order stored in synchronization with the first clock signal when the readout signal indicates a valid value; a first scan test circuit that sequentially captures the test data output from the buffer in synchronization with the first clock signal;
an input terminal;
a reception circuit that sequentially writes the test data input to the input terminal into the buffer in synchronization with a second clock signal; an output terminal;
a transmission circuit that outputs the test data output by the first scan test circuit to the output terminal in synchronization with the second clock signal;
a first test device; and
a second test device comprising:
an output terminal connected to the input terminal of the first semiconductor circuit; a transmission circuit that outputs the test data input from the first test device in synchronization with a third clock signal to the output terminal in synchronization with a fourth clock signal;
a counter circuit configured to count in synchronization with the third clock signal and generate a readout signal when the count reaches a predetermined number;
a buffer configured to store test data and sequentially output the test data in synchronization with the third clock signal when the readout signal indicates a valid value;
an input terminal connected to the output terminal of the first semiconductor circuit;
a reception circuit that sequentially writes the test data input to the input terminal into the buffer in synchronization with the fourth clock signal; and
an output terminal from which the test data from the buffer is output.

11. The semiconductor diagnostic device according to claim 10,
wherein the first test device includes an N-bit test data output, a test clock output, and an N-bit test data input,
wherein the transmission circuit is a serializer that converts N-bit test data into a 1-bit continuous signal,
wherein the reception circuit is a deserializer that converts a 1-bit continuous signal into N-bit test data,
wherein the buffer has an input/output of N-bit test data,
wherein the transmission circuit of the second test device is configured to transmit to the reception circuit of the first semiconductor circuit via a high-speed serial interface circuit, and
wherein the transmission circuit of the first semiconductor circuit is configured to transmit to the reception circuit of the second test device via the high-speed serial interface circuit.

12. A semiconductor device comprising:
a first semiconductor circuit includes:
a counter circuit configured to count in synchronization with a first clock signal and generate a readout signal when the count reaches a predetermined number,
a buffer configured to store test data and sequentially output the test data in the order stored in synchronization with the first clock signal when the readout signal indicates a valid value,
a debug interface that sequentially captures the test data output from the buffer in synchronization with the first clock signal, an input terminal,
a reception circuit that sequentially writes the test data input to the input terminal into the buffer in synchronization with a second clock signal,
an output terminal,
and a transmission circuit that outputs the test data output by the debug interface to the output terminal in synchronization with the second clock signal; and
a second semiconductor circuit includes:
an output terminal connected to the input terminal of the first semiconductor circuit,
a transmission circuit that outputs test data input from a debug device in synchronization with a third clock signal to the output terminal in synchronization with a fourth clock signal,
a counter circuit configured to count in synchronization with the third clock signal and generate a readout signal when the count reaches a predetermined number,
a buffer configured to store test data and sequentially output the test data in the order stored in synchronization with the third clock signal when the readout signal indicates a valid value,
an input terminal connected to the output terminal of the first semiconductor circuit,
a reception circuit that sequentially writes the test data input to the input terminal into the buffer in synchronization with the fourth clock signal, and
an output terminal from which the test data from the buffer is output.

13. The semiconductor device according to claim 12,
wherein the transmission circuit is a serializer that converts N-bit test data into a continuous 1-bit signal,
wherein the reception circuit is a deserializer that converts a continuous 1-bit signal into N-bit test data,
wherein the buffer has an input/output of N-bit test data,
wherein the transmission circuit of the second semiconductor circuit is configured to transmit to the reception circuit of the first semiconductor circuit via a high-speed serial interface circuit, and
wherein the transmission circuit of the first semiconductor circuit is configured to transmit to the reception circuit of the second semiconductor circuit via the high-speed serial interface circuit.
